(19) United States
(12) Patent Application Publication
(10) Pub. No.: US 2008/0038084 A1
(43) Pub. Date: Feb. 14, 2008

(54) FASTENING STRUCTURE AND FASTENING METHOD

(75) Inventors: Kazuaki NAKAMURA, Toyota-shi (JP); Kazuyuki Watanabe, Anjou-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/739,418

(22) Filed: Apr. 24, 2007

(30) Foreign Application Priority Data
May 18, 2006 (JP) 2006-139104

(51) Int. Cl. F16B 35/00; F16J 15/14

(52) U.S. Cl. 411/378; 277/312; 277/590

(57) ABSTRACT

A fastening structure includes a bolt, a fastened member, and gasket material. The fastened member has a bolthole into which the bolt is screwed, and a communication hole that extends from the bolthole to a space other than the bolthole. At least a part of a gap between a thread of the bolt and a thread of the bolthole, and at least a part of the communication hole are filled with the gasket material.

### INCORPORATION BY REFERENCE

The disclosure of Japanese Patent Application No. 2006-139104 filed on May 18, 2006 including the specification, drawings and abstract is incorporated herein by reference in its entirety.

### BACKGROUND OF THE INVENTION

1. Field of the Invention

The invention relates to a fastening structure and a fastening method. More particularly, the invention relates to a fastening structure and a fastening method, in which a gasket is provided between a bolt and a member to which the bolt is fastened.

2. Description of the Related Art

Japanese Patent Application Publication No. JP-A-2001-317633 describes bolt-fastening structure.

Publication No. JP-A-2001-317633 describes a structure in which a bolt is screwed into a bolthole in a liquid-tight manner so that the bolthole is closed. In this structure, after a liquid gasket is applied to the bolt, the bolt is inserted in the bolthole. As a result, the liquid gasket (i.e., filling material) is pushed out to fill the gap between the bolt and the bolthole. Because the bolt is screwed into the bolthole in the liquid-tight manner, the pressure of air and the liquid gasket in the bottom of the bolthole increases. As a result, the liquid gasket spills out of the bolthole, and the level of sealing performance decreases.

### SUMMARY OF THE INVENTION

The invention provides a fastening structure and a fastening method that provide high sealing performance.

A fastening structure according to a first aspect of the invention includes a bolt, a fastened member, and gasket material. The fastened member has a bolthole into which the bolt is screwed, and a communication hole that extends from the bolthole to a space other than the bolthole. At least a part of a gap between the thread of the bolt and the thread of the bolthole, and at least a part of the communication hole are filled with the gasket material.

In this fastening structure, air and the gasket material are discharged to the outside of the bolthole through the communication hole when the bolt is screwed into the bolthole. This prevents the gasket material from spilling out of the bolthole. As a result, high sealing performance is provided. Also, the communication hole is closed by the gasket material. This prevents a decrease in the sealing performance due to the communication hole.

An attachment body may be further provided between the head of the bolt and the fastened member. The head may press the attachment body toward the fastened member.

A fastening method according to a second aspect of the invention includes placing gasket material in a space defined by the bottom surface of the bolt and the bolthole provided in a fastened member; and screwing the bolt into the bolthole so that the bolt is fastened to the fastened member wherein a communication hole that extends from the bolthole to a space other than the bolthole, and at least a part of a gap between the thread of the bolthole and the thread of the bolt, and at least a part of the communication hole are filled with the gasket material.

According to the above-described aspects, it is possible to provide the fastening structure and the fastening method that provide high sealing performance.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a sectional view showing a fastening structure according to a first example of a first embodiment of the invention;

FIG. 2 is a sectional view explaining a fastening method according to a first example of a second embodiment of the invention;

FIG. 3 is a sectional view explaining a fastening method according to a second example of the second embodiment of the invention; and

FIG. 4 is a sectional view showing a fastening structure according to a second example of the first embodiment of the invention.

### DETAILED DESCRIPTION OF THE EXAMPLE EMBODIMENTS

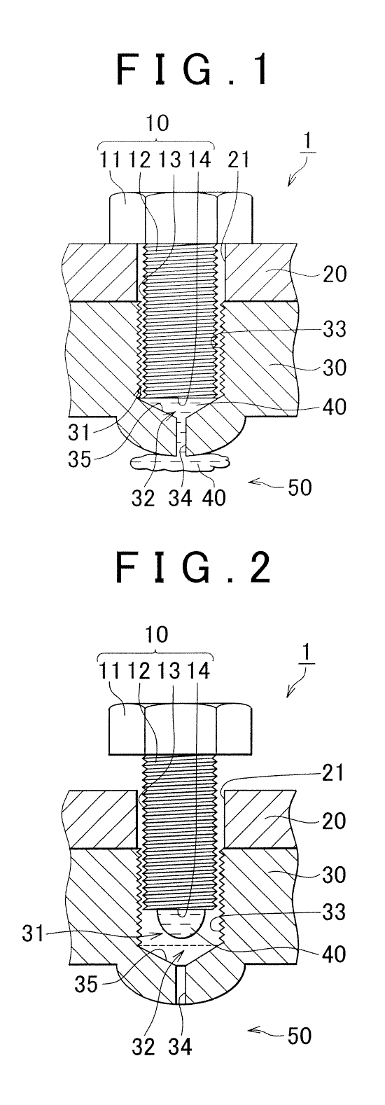

FIG. 1 is a sectional view showing a fastening structure according to an example of the first embodiment of the invention. As shown in FIG. 1, in the fastening structure 1, the bolt 10 is fastened to a member 30 (hereinafter, the member 30, to which the bolt 10 is fastened, will be referred to as “fastened member 30”). The bolt 10 includes a head portion 11; a shaft portion 12, connected to the head portion 11, that has a cylindrical shape; a thread 13 formed on the surface of the shaft portion 12; and a bottom surface 14 that is opposite the head portion 11. The head portion 11 has a hexagonal shape. The outer surface of the head portion 11 may be held by a spanner or the like to rotate the bolt 10. A hexagonal indentation may be formed in the head portion 11. A hexagonal wrench may be inserted in the hexagonal indentation to rotate the bolt 10.

Alternatively, the head portion 11 may have a butterfly nut shape so that the head portion 11 can be manually rotated. The shaft portion 12 extends in the axial direction. The diameter of the shaft portion 12 is smaller than that of the head portion 11. When the shaft portion 12 is screwed into a hole which is provided in the fastened member 30, the shaft portion 12 stretches. This generates the axial tension. The bolt 10 is fastened to the fastened member 30 due to the axial tension.

The spiral thread 13 is formed on the surface of the shaft portion 12. The thread 13 may be a single thread or a double thread. Also, the thread 13 may be a right-hand thread or a left-hand thread.

The bottom surface 14 contacts the gasket material 40. The bottom surface 14 is positioned at the lowest area in the fastened member 30. The fastened member 30 has a bolthole 31. A thread 33 is formed on the inner surface of the bolthole 31. The thread 33 engages with the thread 13 of the bolt 10. This prevents the bolt 10 from coming out of the bolthole 31.

A space 32 is formed at the bottom of the bolthole 31. The space 32 is defined by the bolthole 31 and the bottom surface 14. The space 32 is filled with the gasket material 40. The gasket material 40 may be in the form of a solid, gel, or sol. The gasket material 40 seals the bolthole 31, and a communication hole 34 in a liquid-tight manner. The communication hole 34 has a small diameter. The viscosity of the gasket material 40 may be constant. Alternatively, the viscosity of the gasket material 40 may increase (i.e., the gasket material 40 may be hardened) when the gasket material 40 contacts air. The gasket material 40 may be composed of inorganic material. The gasket material 40 is provided between the thread 13 of the bolt 10 and the thread 33 of the bolthole 31. Thus, the gasket material 40 seals the gap between the thread 13 of the bolt 10 and the thread 33 of the bolthole 31. The gasket material 40 protrudes through the communication hole 34 to a space 50 outside the fastened member 30. In this embodiment, the entire communication hole 34 is filled with the gasket material 40. However, the invention is not limited to this configuration. Only a part of the communication hole 34 may be filled with the gasket material 40. In this first embodiment, only the lower part of the gap between the thread 13 of the bolt 10 and the thread 33 of the bolthole 31 is filled with the gasket material 40. However, the invention is not limited to this configuration. The entire gap between the thread 13 of the bolt 10 and the thread 33 of the bolthole 31 may be filled with the gasket material 40.

The bottom surface of the bolthole 31 may be tapered. In addition, the communication hole 34 may extend from the center of the bolthole 31. However, the shape of the bottom surface of the bolthole 31 is not limited to a particular shape. The bottom surface of the bolt 31 may instead be flat. In this case, the bottom surface is orthogonal to the axial direction of the bolt. The communication hole 34 may be positioned somewhere other than at the center of the shaft portion 12. That is, the communication hole 34 may be offset to one side of the shaft portion 12. In this embodiment, the diameter of the communication hole 34 is smaller than that of the bolthole 31. However, the invention is not limited to this configuration. The diameter of the communication hole 34 may be larger than that of the bolthole 31.

In this embodiment, the inner diameter of the communication hole 34 is constant. However, the invention is not limited to this configuration. For example, the inner diameter of the communication hole 34 may change from one side to the other side. The communication hole 34 extends straight in FIG. 1. However, the communication hole 34 does not have to be straight; instead the communication hole may also be curved. In this embodiment, the inner diameter of the bolthole 31 is constant. However, the bolthole 31 may be tapered. That is, the inner diameter of the bolthole 31 may decrease toward the bottom of the bolthole 31.

The entire communication hole 34 does not necessarily need to be filled with the gasket material 40. That is, at least a part of the communication hole 34 is filled with the gasket material 40.

An attachment body 20 is fixed at a position between the fastened member 30 and the head portion 11. The attachment body 20 has an opening 21. The shaft portion 12 is inserted through the opening 21.

In the first embodiment, the attachment body 20 may be omitted. FIG. 4 is a sectional view showing a fastening structure according to a second example of the first embodiment. As shown in FIG. 4, the fastening structure 1 in the second example of the first embodiment is the same as the fastening structure 1 in the first example of the first embodiment, except that the attachment body 20 is not provided. In the second example, the attachment body 20 is not attached to the fastened member 30 by the bolt 10. The bolt 10 is screwed into the fastened member 30 to function as an anchor bolt. For example, the bolt 10 may be provided with a hook 60. In this case, when the bolt 10 is used, some loads are applied to the hook 60. The hook 60 does not necessarily need to be provided. The space 50 may be a closed space, or an open space. For example, a main component such as a transmission or an engine, may be provided in the space 50.

The fastening structure 1 in the second example of the first embodiment has the same effects as those of the fastening structure 1 in the first example of the first embodiment.

The fastening structure 1 according to the first embodiment of the invention includes the bolt 10, the fastened member 30, and the gasket material 40. The fastened member 30 has the bolthole 31 into which the bolt 10 is screwed, and the communication hole 34 that extends from the bolthole 31 to the space 50. At least a part of the gap between the thread 13 of the bolt 10 and the thread 33 of the bolthole 31, and at least a part of the communication hole 34 are filled with the gasket material 40. The volume of the gasket material 40 is greater than the volume of the space 32 defined by the bottom surface 14 of the bolt 10 and the bolthole 31 when the bolt 10 is screwed into the bolthole 31. The fastening structure 1 may further include the attachment body 20 provided between the head portion 11 of the bolt 10 and the fastened member 30. The head portion 11 of the bolt 10 presses the attachment body 20 toward the fastened member 30. The bottom surface 35 of the bolthole 31 may or may not contact the bottom surface 14 of the bolt 10.

Next, a fastening method according to a second embodiment will be described. FIG. 2 is a sectional view explaining the fastening method according to a first example of the second embodiment. As shown in FIG. 2, in the fastening method according to the first example, the gasket material 40, which is sealing material, is attached to the bottom surface 14 of the bolt 10. The bottom surface 14 may be irregular so that the gasket material 40 is easily attached to the bottom surface 14. A hole may be formed in the bottom surface 14 so that the gasket material 40 accumulates in the hole. After the gasket material 40 is attached to the bottom surface 14, the bolt 10 is screwed into the bolthole 31 so that the thread 13 of the bolt 10 engages with the thread 33 of the bolthole 31. Thus, the gasket material 40 comes closer to the bottom surface 35 of the bolthole 31. Finally, the gasket material 40 contacts the bottom surface 35. As the bolt 10 is further screwed into the bolthole 31, the gasket material 40 is deformed. Part of the gasket material 40 spreads in the gap between the thread 33 and the thread 13. Also, the communication hole 34 is filled with part of the gasket material 40. When the gap between the thread 33 of the bolthole 31 and the thread 13 of the bolt 10 is filled with the gasket material 40 to form a seal, air left in the bottom of the bolthole 31 is released to the space 50 through the communication hole 34. This prevents an increase in the pressure in the bottom of the bolthole 31.

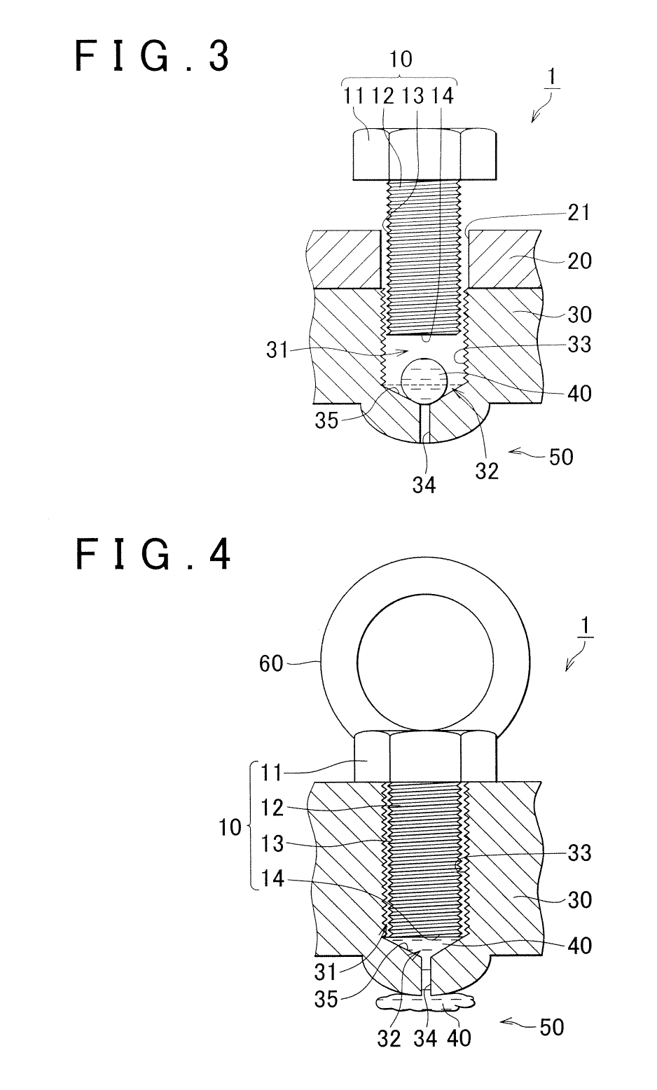

FIG. 3 is a sectional view shows a fastening method according to a second example of the second embodiment. As shown in FIG. 3, in the second example, the gasket material 40 may initially be placed in contact with the bottom surface 35. In this case, the bolt 10 is screwed into the bolthole 31 so that the thread 13 of the bolt 10 engages with the thread 33 of the bolthole 31. Then, after the bottom surface 14 contacts the gasket material 40, the bolt 10 is further screwed into the bolthole 31. As a result, the gasket material 40 is deformed to spread in the gap between the thread 13 of the bolt 10 and the thread 33 of the bolthole 31. Thus, the bolt 10 is securely screwed into the bolthole 31.

The fastening method according to the first example of the second embodiment includes attaching the gasket material 40 to the bottom surface 14 of the bolt 10; and screwing the bolt 10 with the gasket material 40 into the bolthole 31 so that the bolt 10 is fastened to the fastened member 30, and at least a part of the gap between the thread 33 of the bolthole 31 and the thread 13 of the bolt 10, and at least a part of the communication hole 34 are filled with the gasket material 40.

The fastening method according to the second example of the second embodiment includes placing the gasket material 40 at the bottom of the bolthole 31; and screwing the bolt 10 into the bolthole 31 in which the gasket material 40 is placed so that the bolt 10 is fastened to the fastened member 30, and at least a part of the gap between the thread 33 of the bolthole 31 and the thread 13 of the bolt 10 and at least a part of the communication hole 34 are filled with the gasket material 40.

According to the second embodiment of the invention, air and the liquid gasket material 40 are discharged to the outside of the bolthole 31 through the communication hole 34. This prevents the gasket material 40 from spilling out of the bolthole 31. Thus, high sealing performance is provided. Also, the liquid gasket material 40 closes the communication hole 34. This prevents a decrease in the sealing performance due to the communication hole 34.

Conventionally, when a sealing bolt coated with sealing material or a bolt coated with anti-loosening agent is screwed into a closed-end bolthole, air and a liquid gasket are not discharged to the outside of the bolthole due to the sealing material or the like that provides air-tight sealing. Thus, air and the liquid gasket are compressed. As a result, the sealing material may be spilled out of the bolthole. This decreases the level of air-tightness. In contrast, according to the embodiment of the invention, air and the liquid gasket are discharged to the outside of the bolthole through the communication hole 34. Further, because the communication hole 34 is filled with the liquid gasket 40, the communication hole 34 is sealed. This prevents oil leaks, and the like. Also, the amount of gasket material 40 that protrudes toward the head portion 11 is adjusted. Thus, an ordinary bolt can be used as a sealing bolt.

Thus, the embodiment of the invention that has been disclosed in the specification is to be considered in all respects as illustrative and not restrictive. The technical scope of the invention is defined by claims, and all modifications that come within the meaning and range of equivalency of the claims are therefore intended to be embraced therein.

What is claimed is:

1. A fastening structure comprising:
a bolt;
a fastened member that has a bolthole into which the bolt is screwed, and a communication hole that extends from the bolthole to a space other than the bolthole; and
gasket material with which at least a part of a gap between a thread of the bolt and a thread of the bolthole, and at least a part of the communication hole are filled.

2. The fastening structure according to claim 1, wherein a volume of the gasket material is greater than a volume of a space defined by a bottom surface of the bolt and the bolthole when the bolt is screwed into the bolthole.

3. The fastening structure according to claim 1, further comprising:
an attachment body provided between a head of the bolt and the fastened member, wherein the head of the bolt presses the attachment body toward the fastened member.

4. The fastening structure according to claim 1, wherein a bottom surface of the bolt is irregular.

5. A fastening method, comprising:
placing gasket material in a space defined by a bottom surface of a bolt and a bolthole provided in a fastened member into which the bolt is screwed; and
screwing the bolt into the bolthole so that the bolt is fastened to the fastened member wherein a communication hole that extends from the bolthole to a space other than the bolthole, and at least a part of a gap between a thread of the bolthole and a thread of the bolt, and at least a part of the communication hole are filled with the gasket material.

6. The fastening method according to claim 5, wherein the gasket material is placed on the bottom surface of the bolt.

7. The fastening method according to claim 5, wherein the gasket material is placed at a bottom of the bolthole.
